(19) United States
(12) Patent Application Publication
(10) Pub. No.: US 2009/0126328 A1
(43) Pub. Date: May 21, 2009

(54) Working Vehicle With Front-Mount Mower

(76) Inventor: Hiroaki SHIMIZU, Amagasaki-shi (JP)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/271,644

(22) Filed: Nov. 14, 2008

Related U.S. Application Data
(60) Provisional application No. 60/989,340, filed on Nov. 20, 2007.

(51) Int. Cl. A01D 43/06; A01D 43/00

(52) U.S. Cl. 56/16.6; 56/202

(57) ABSTRACT

The working vehicle with front-mount mower according to the present invention makes it possible to secure, in the center in a vehicle widthwise direction, a free space used for positioning a discharge duct without being affected by a pump-side transmission mechanism that transmits rotational power from a driving power source to a hydraulic pump main body and a PTO-side transmission mechanism that transmits rotational power from the driving power source to a mower. Accordingly, it is possible to improve design freedom of the discharge duct, thereby eliminating the use of or downsizing a blower, which has been vital in the conventional techniques.

### BACKGROUND OF THE INVENTION

1. Field of the Invention

The present invention relates to a working vehicle with front-mount mower provided with a mower, a container, and a discharge duct that configures a conveyance path used for conveying grass mown by the mower to the container, wherein the mower and the container are disposed in front of and behind a pair of left and right driving wheels, respectively.

2. Background Art

As described in European Patent Specification No. 0 840 998 (hereinafter, referred to as prior document 1) and U.S. Pat. No. 4,835,951 (hereinafter, referred to as prior document 2), there is known a working vehicle with front-mount mower provided with a mower, a container that accommodates grass mown by the mower, and a discharge duct that configures a conveyance path used for conveying the mown grass from the mower to the container, wherein the mower and the container are disposed in front of and behind a pair of left and right driving wheels, respectively.

In the working vehicle with front-mount mower, since the pair of left and right driving wheels are positioned in the center in a vehicle lengthwise direction, the working vehicle has a smaller turning radius so as to ease mowing in the periphery of trees. Further, the working vehicle thus configured is effective in that a user is allowed to mow grass located very close to an edge of a garden with clear sight to the vicinity of a front part as well as a bottom part of the working vehicle.

However, the conventional working vehicle with front-mount mower raises a problem that flexibility is limited in designing the discharge duct.

The working vehicle described in the prior document 1 includes a mechanical differential gear mechanism that is disposed between the pair of driving wheels so as to be inserted in a traveling transmission path running from a driving power source to the pair of driving wheels.

Thus, in the working vehicle described in the prior document 1, the discharge duct needs to be designed so as not to interfere with an axle housing that accommodates the mechanical differential gear mechanism.

Specifically, as shown in FIG. 4 of the prior document 1, the discharge duct has an inclined part that is steeply inclined rearwards as well as upwards from the mower so as to keep away from the axle housing, and a horizontal part that extends rearwards in a substantially horizontal direction from the inclined part.

The working vehicle of the prior document 1 in the above configuration requires a blower for conveying mown grass through the inclined part to the container without clogging.

On the other hand, the working vehicle described in the prior document 2 includes a pair of first and second hydrostatic transmissions (HSTs) that independently and respectively drive the pair of driving wheels, and thus the mechanical differential gear mechanism does not need to be provided between the pair of driving wheels.

Nevertheless, in the working vehicle described in the prior document 2, hydraulic pump main bodies and hydraulic motor main bodies included respectively in the first and second HSTs are all accommodated integrally in one HST housing, and are disposed in the center in a vehicle widthwise direction (see FIG. 6 of the prior document 2). Moreover, in the working vehicle of the prior document 2, power transmission members for transmitting power from the driving power source to the first and second HSTs pass through the center in the vehicle widthwise direction.

Thus, in the working vehicle of the prior document 2, the discharge duct needs to be designed so as not to interfere with the first and second HSTs as well as the power transmission members.

Specifically, as shown in FIG. 8 of the prior document 2, the discharge duct has a flat horizontal part that extends rearwards in the substantially horizontal direction from the mower so as to be positioned below the first and second HSTs, and a vertical part that extends upwards in a substantially vertical direction from the horizontal part.

The working vehicle of the prior document 2 in the above configuration requires a blower for conveying mown grass through the vertical part to the container without clogging.

### BRIEF SUMMARY OF THE INVENTION

In view of the above conventional techniques, it is an object of the present invention to provide a working vehicle with front-mount mower including a mower, a container and a discharge duct that configures a conveyance path used for conveying grass mown by the mower to the container, wherein the mower and the container are respectively disposed on sides forward and rearward of a pair of left and right driving wheels, the working vehicle with front-mount mower capable of improving design freedom of the discharge duct.

The present invention provides, in order to achieve the object, a working vehicle with front-mount mower including a vehicle frame that has a pair of left and right main frames extending in a vehicle lengthwise direction, a pair of left and right driving wheels, a mower supported by the vehicle frame on a side forward of the driving wheels, a container supported by the vehicle frame on a side rearward of the driving wheels, a discharge duct that forms a conveyance path used for conveying grass mown by the mower to the container, a driving power source supported by the vehicle frame on a side rearward of the mower, a traveling speed-change device inserted in a traveling transmission path running from the driving power source to the pair of left and right driving wheels, and a PTO-side transmission mechanism that forms a PTO transmission path running from the driving power source to the mower, wherein, (a) the traveling speed-change device includes a hydraulic pump main body that operatively receives rotational power from the driving power source, a first hydraulic motor main body that forms a first HST for the left driving wheel in cooperation with the hydraulic pump main body, and a second hydraulic motor main body that forms a second HST for the right driving wheel in cooperation with the hydraulic pump main body; (b) the hydraulic pump main body is independently disposed while being away from the first and second hydraulic motor main bodies; (c) the first and second hydraulic motor main bodies are disposed independently in the vicinity of the corresponding left and right driving wheels while being away from each other so as to secure a free space between the first and second hydraulic motor main bodies; (d) the discharge duct is disposed in the free space between the first and second hydraulic motor main bodies in plan view; and (e) the PTO-side transmission mechanism is configured to transmit rotational power from the driving power source to the mower via a PTO-side power transmission member that extends in the vehicle lengthwise direction within one of a left space provided in plan view between the left main frame and the discharge duct and a right space provided in plan view between the right main frame and the discharge duct.

The working vehicle with front-mount mower according to the present invention makes it possible to secure, in the center in a vehicle widthwise direction, a free space used for positioning the discharge duct without being affected by a pump-side transmission mechanism that transmits rotational power from the driving power source to the hydraulic pump main body and the PTO-side transmission mechanism that transmits rotational power from the driving power source to the mower. Accordingly, it is possible to improve design freedom of the discharge duct, thereby eliminating the use of or downsizing a blower, which has been vital in the conventional techniques.

In one embodiment, the hydraulic pump main body includes a first hydraulic pump main body for the left driving wheel that operatively receives rotational power from the driving power source and that is fluidly connected to the first hydraulic motor main body, and a second hydraulic pump main body for the right driving wheel that operatively receives rotational power from the driving power source and that is fluidly connected to the second hydraulic motor main body.

In the one embodiment, the working vehicle may preferably include a single pump unit that includes the first and second hydraulic pump main bodies.

The pump unit includes an input shaft operatively connected to the driving power source, the first and second hydraulic pump main bodies operatively connected to the input shaft, and a pump case accommodating the first and second hydraulic pump main bodies and supporting the input shaft, the pump case being formed with a pair of first-pump hydraulic fluid channels that have first ends fluidly connected to the first hydraulic pump main body and second ends opened to an outer surface, and a pair of second-pump hydraulic fluid channels that have first ends fluidly connected to the second hydraulic pump main body and second ends opened to the outer surface.

In another one embodiment, the first and second hydraulic motor main bodies are fluidly connected in parallel to the hydraulic pump main body.

In the above various configurations, the working vehicle may includes a first wheel motor device for driving the left driving wheel and a second wheel motor device for driving the right driving wheel.

The first wheel motor device includes the first hydraulic motor main body, a first deceleration mechanism that decelerates rotational power output from the first hydraulic motor main body, a first output member that outputs the rotational power decelerated by the first deceleration mechanism to the left driving wheel, and a first housing that accommodates the first hydraulic motor main body and the first deceleration mechanism and that supports the first output member, the first housing being formed with a pair of first-motor hydraulic fluid channels having first ends fluidly connected to the first hydraulic motor main body and second ends opened to an outer surface, and being directly or indirectly supported by the left main frame.

The second wheel motor device includes the second hydraulic motor main body, a second deceleration mechanism that decelerates rotational power output from the second hydraulic motor main body, a second output member that outputs the rotational power decelerated by the second deceleration mechanism to the right driving wheel, and a second housing that accommodates the second hydraulic motor main body and the second deceleration mechanism and that supports the second output member, the second housing being formed with a pair of second-motor hydraulic fluid channels having first ends fluidly connected to the second hydraulic motor main body and second ends opened to an outer surface, and being directly or indirectly supported by the right main frame.

In the above various configurations, the driving power source may have an output shaft extending substantially horizontally.

In the configuration, the PTO-side transmission mechanism includes a driving pulley supported by the output shaft in a relatively non-rotatable manner, and an endless belt that is wound around the PTO-side driving pulley so as to rotate along a rotational trajectory in a substantially vertical surface and that functions as the PTO-side power transmission member.

Alternatively, the PTO-side power transmission member may be formed by a PTO-side transmission shaft provided at both ends with universal joints.

For example, the driving power source may be disposed higher than the driving wheels and between a driver's seat and the container in the vehicle lengthwise direction.

Alternatively, the driving power source may be disposed rearward of the pair of driving wheels and below the container.

### BRIEF DESCRIPTION OF THE DRAWINGS/FIGURES

FIG. 1 is a side view of a working vehicle with front-mount mower according to a first embodiment of the present invention.

FIG. 2 is a plan view of the working vehicle shown in FIG. 1.

FIG. 3 is a hydraulic circuit diagram of the working vehicle shown in FIGS. 1 and 2.

FIG. 4 is a vertical cross-sectional expanded view of a first wheel motor device provided in the working vehicle according to the first embodiment, and shows a cross-section taken along line IV-IV in FIG. 2.

FIG. 5 is vertical cross-sectional expanded view of a wheel motor device according to a first modified example.

FIG. 6 is vertical cross-sectional expanded view of a wheel motor device according to a second modified example.

FIG. 7 is vertical cross-sectional expanded view of a wheel motor device according to a third modified example.

FIG. 8 is a side view of a working vehicle according to a first modified example of the first embodiment.

FIG. 9 is a plan view of the working vehicle shown in FIG. 8.

FIG. 10 is a side view of a working vehicle according to a second modified example of the first embodiment.

FIG. 11 is a plan view of the working vehicle shown in FIG. 10.

FIG. 12 is a hydraulic circuit diagram of a working vehicle with front-mount mower according to a second embodiment of the present invention.

### DETAILED DESCRIPTION OF THE INVENTION

### First Embodiment

Hereinafter, one preferred embodiment of the present invention will be described with reference to the accompanying drawings.

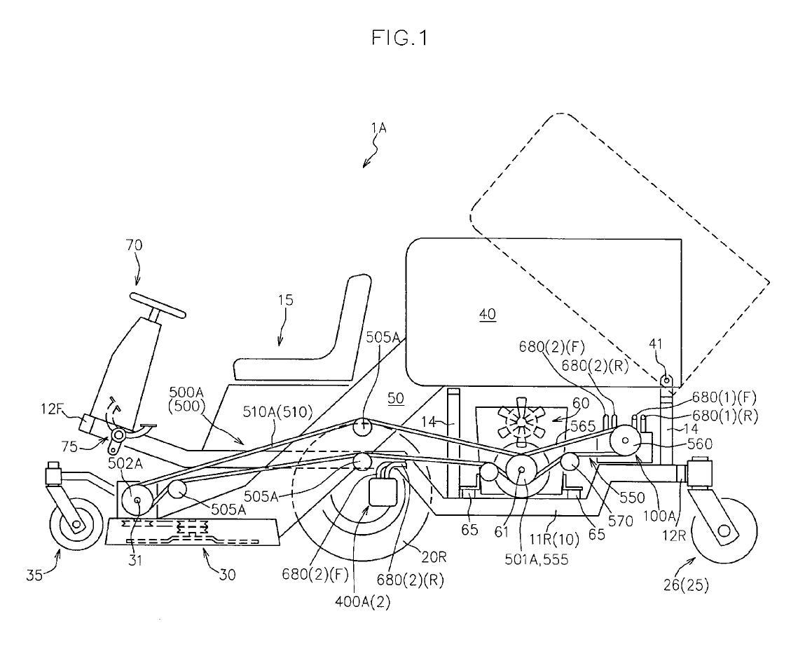

FIGS. 1 to 3 are a side view, a plan view, and a hydraulic circuit diagram, respectively, of a working vehicle 1A with front-mount mower according to a preferred embodiment of the present invention.

As shown in FIGS. 1 to 3, the working vehicle 1A includes a vehicle frame 10 having a pair of left and right main frames 11L, 11R that extend in a vehicle lengthwise direction, a pair of left and right driving wheels 20L, 20R, a mower 30 supported by the vehicle frame 10, a container 40 supported by the vehicle frame 10, a discharge duct 50 that configures a conveyance path used for conveying grass mown by the mower 30 to the container 40, a driving power source 60 supported by the vehicle frame 10 on a side rearward of the mower 30, a traveling speed-change device inserted in a traveling transmission path running from the driving power source 60 to the pair of left and right driving wheels 20L, 20R, a PTO-side transmission mechanism 500 that configures a PTO transmission path running from the driving power source 60 to the mower 30, a driver's seat 15, a steering operation member 70 such as a steering wheel that is disposed in front of the driver's seat 15 and is used for steering control of the working vehicle 1A, a speed-change operation member 75 such as an accelerator pedal that is disposed in the vicinity of the driver's seat 15 and is used for shifting a traveling direction and a traveling speed of the working vehicle 1A, and an auxiliary wheel 25 disposed apart from the pair of driving wheels 20 in the vehicle lengthwise direction.

It should be noted that, unless specifically described, the terms “left” and “right” indicate left and right, respectively, in a vehicle forward traveling direction.

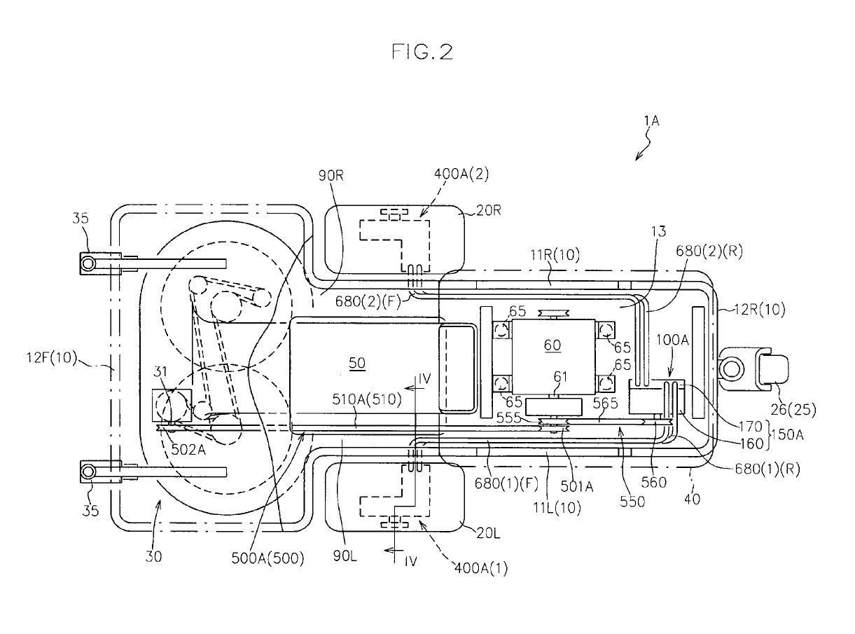

As shown in FIGS. 1 and 2, the vehicle frame 10 has the pair of left and right main frames 11L, 11R, and a front cross frame 12F and a rear cross frame 12R that connect respectively front and rear sides of the pair of left and right main frames 11L, 11R.

As shown in FIGS. 1 and 2, in the present embodiment, the driving power source 60 is disposed behind the pair of left and right driving wheels 20L, 20R.

Specifically, the vehicle frame 10 has a mounting plate 13 that is disposed behind the pair of left and right driving wheels 20L, 20R and connects the pair of left and right mainframes 11L, 11R.

The driving power source 60 is supported in a vibration-absorbing manner by the mounting plate 13 via vibration-absorbing rubbers 65.

The driving power source 60 is embodied as an internal combustion engine, an electric motor, or the like.

As shown in FIGS. 1 and 2, the container 40 is supported by the vehicle frame 10 so as to be disposed on a side rearward of the pair of left and right driving wheels 20L, 20R.

In the present embodiment, the container 40 is supported by the vehicle frame 10 so as to be positioned above the driving power source 60.

Specifically, as shown in FIG. 1, the vehicle frame 10 has, in addition to the above configuration, a support frame 14 that stands on the pair of left and right main frames 11L, 11R.

The container 40 is supported by the support frame 14 so as to be positioned above the driving power source 60.

Preferably, the container 40 is supported in the vicinity of its rear and lower end by the vehicle frame 10 so as to be rotatable rearwards about a pivotal shaft 41 (see FIG. 1) along the vehicle widthwise direction.

Moreover, the container 40 has a rear end wall capable of being opened.

The above-described configuration facilitates discharge of mown grass that is accommodated in the container 40.

The mower 30 is supported in a liftable manner by the vehicle frame 10 on a side forward of the pair of left and right driving wheels 20L, 20R with use of an ordinary hitch connection mechanism (not shown).

As described above, in the working vehicle 1A according to the present embodiment, the mower 30 and the container 40 are positioned respectively on sides forward and rearward of the pair of left and right driving wheels 20L, 20R, so as to improve balance in vehicle weight.

Further, in the above configuration, the pair of left and right driving wheels 20L, 20R are positioned substantially in the center in the vehicle lengthwise direction, so that the working vehicle 1A is allowed to have a smaller turning radius.

As described earlier, in the present embodiment, the driving power source 60 is disposed on a side rearward of the pair of left and right driving wheels 20L, 20R as well as below the container 40, so that the working vehicle 1A may have a barycentric position as lowered as possible.

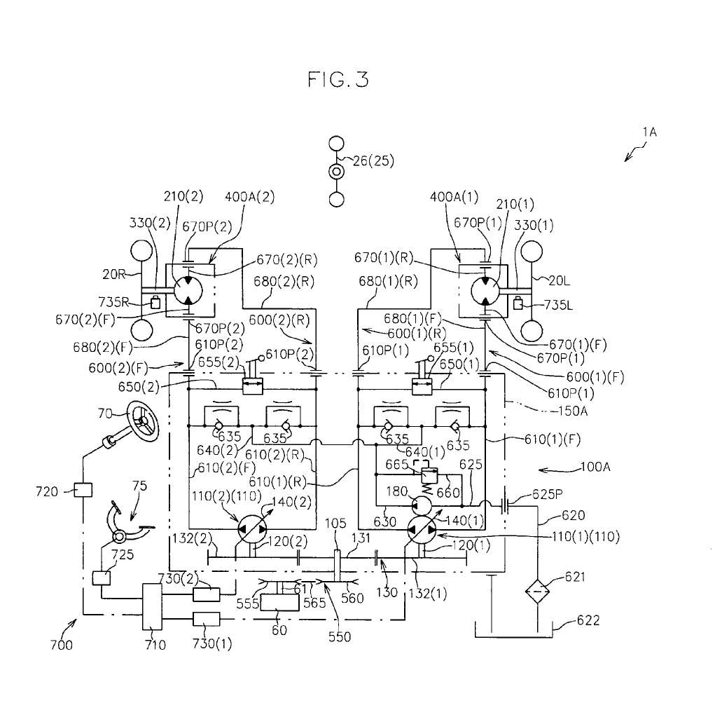

As shown in FIG. 3, the traveling speed-change device includes a hydraulic pump main body 110 that operatively receives rotational power from the driving power source 60, a first hydraulic motor main body 210(1) that configures a first HST for the left driving wheel 20L in cooperation with the hydraulic pump main body 110, and a second hydraulic motor main body 210(2) that configures a second HST for the right driving wheel 20R in cooperation with the hydraulic pump main body 110.

In the present embodiment, the hydraulic pump main body 110, the first hydraulic motor main body 210(1), and the second hydraulic motor main body 210(2) are configured so as to be disposed apart from one another.

Specifically, the hydraulic pump main body 110 can be disposed independently at an arbitrary position on the vehicle frame 10 while being fluidly connected to the first hydraulic motor main body 210(1) and the second hydraulic motor main body 210(2) via conduits that are to be described later, so as to simplify a configuration of a pump-side transmission mechanism 550 that transmits rotational power from the driving power source 60 to the hydraulic pump main body 110.

The first and second hydraulic motor main bodies 210(1), 210(2) are disposed apart from each other as well as from the hydraulic pump main body 110 while being fluidly connected to the hydraulic pump main body 110 via HST conduits 680(1), 680(2) that are to be described later, so as to simplify a configuration of a transmission mechanism that transmits rotational power to the corresponding driving wheels 20L, 20R, respectively, as well as to secure a free space between the pair of left and right driving wheels 20L, 20R.

Specifically, the first hydraulic motor main body 210(1) is disposed in the vicinity of the corresponding left driving wheel 20L and the second hydraulic motor main body 210(2) is disposed in the vicinity of the corresponding right driving wheel 20R, so as to effectively secure the free space in the center in the vehicle widthwise direction.

As shown in FIG. 3, the working vehicle 1A according to the present embodiment includes, as the hydraulic pump main body 110, a first hydraulic pump main body 110(1) for the left driving wheel 20L and a second hydraulic pump main body 110(2) for the right driving wheel 20R. The first hydraulic pump main body 110(1) operatively receives rotational power from the driving power source 60, and is fluidly connected to the first hydraulic motor main body 210(1) via a pair of first HST lines 600(1) so as to configure the first HST in cooperation with the first hydraulic motor main body 210(1). The second hydraulic pump main body 110(2) operatively receives rotational power from the driving power source 60, and is fluidly connected to the second hydraulic motor main body 210(2) via a pair of second HST lines 600(2) so as to configure the second HST in cooperation with the second hydraulic motor main body 210(2).

The first HST lines 600(1) include a forward-movement high-pressure-side first HST line 600(1)(F) that is highly pressurized at a forward movement of the vehicle, and a rearward-movement high-pressure-side first HST line 600(1)(R) that is highly pressurized at a rearward-movement of the vehicle.

The second HST lines 600(2) include a forward-movement high-pressure-side HST line 600(2)(F) that is highly pressurized at the forward movement of the vehicle, and a rearward-movement high-pressure-side second HST line 600(2)(R) that is highly pressurized at the rearward movement of the vehicle.

At least one of the first hydraulic pump main body 110(1) and the first hydraulic motor main body 210(1) is of a variable displacement type so that the first HST is configured by the first hydraulic pump main body 110(1) and the first hydraulic motor main body 210(1). Similarly, at least one of the second hydraulic pump main body 110(2) and the second hydraulic motor main body 210(2) is of the variable displacement type so that the second HST is configured by the second hydraulic pump main body 110(2) and the second hydraulic motor main body 210(2).

As shown in FIG. 3, in the present embodiment, the first and second hydraulic pump main bodies 110(1), 110(2) are of the variable displacement type, while the first and second hydraulic motor main bodies 210(1), 210(2) are of a fixed displacement type.

The working vehicle 1A thus configured could control, independently from each other, rotational output from the first HST (that is, rotational output from the first hydraulic motor main body 210(1)) and rotational output from the second HST (that is, rotational output from the second hydraulic motor main body 210(2)), so that the working vehicle 1A can make a turn at an arbitrary angle from a gentle turn to a zero turn.

Accordingly, the working vehicle 1A has, as the auxiliary wheel 25, a driven wheel 26 such as a caster wheel.

It is possible that the working vehicle 1A is provided with only one driven wheel 26 disposed in the center in the vehicle widthwise direction. Alternatively, it is also possible that the working vehicle 1A is provided with a pair of driven wheels 26 respectively disposed on both sides in the vehicle widthwise direction. The driven wheel 26(s) may be positioned behind or below the container 40.

The working vehicle 1A according to the present embodiment further includes gauge wheels 35 that are disposed on a side forward of the mower 30 in order to stably support the mower 30 and set a height of the mower 30.

The working vehicle 1A according to the present embodiment includes one hydraulic pump unit 100A that has the first and second hydraulic pump main bodies 110(1), 110(2) and that can be independently disposed in the vicinity of the driving power source 60.

Specifically, as shown in FIG. 3, the hydraulic pump unit 100A includes an input shaft 105 that is operatively connected to the driving power source 60 via the pump-side transmission mechanism 550, the first and second hydraulic pump main bodies 110(1), 110(2), first and second pump shafts 120(1), 120(2) that respectively support the first and second hydraulic pump main bodies 110(1), 110(2) in a relatively non-rotatable manner, a gear transmission mechanism 130 that transmits rotational power from the input shaft 105 to the first and second pump shafts 120(1), 120(2), and a pump case 150A that accommodates the first hydraulic pump main body 110(1), the second hydraulic pump main body 110(2), and the gear transmission mechanism 130, as well as supports the input shaft 105, the first pump shaft 120(1), and the second pump shaft 120(2).

The input shaft 105 is supported by the pump case 150A in a state where a first end of the input shaft 105 extends outwards so as to configure an input end.

In the present embodiment, the first end of the input shaft 105 supports in a relatively non-rotatable manner a pump-side driven pulley 560 that forms a part of the pump-side transmission mechanism 550.

In the present embodiment, the driving power source 60 has an output shaft 61 that extends substantially horizontally and outwards in the vehicle widthwise direction from a main body of the driving power source 60 that is supported by the mounting plate 13.

The hydraulic pump unit 100A is supported by the mounting plate 13 in the vicinity of the driving power source 60 such that the first end of the input shaft 105 extends substantially horizontally to be in parallel with a rotational axis line of the output shaft 61. According to the configuration, the pump-side transmission mechanism 550 is allowed to have a simplified configuration.

In the above-described configuration, the pump-side transmission mechanism 550 has a pump-side driving pulley 555 that is supported by the output shaft 61 in a relatively non-rotatable manner, the pump-side driven pulley 560 that is supported by the first end of the input shaft 105 in a relatively non-rotatable manner, and a pump-side endless belt 565 that is wound around the pump-side driving pulley 555 and the pump-side driven pulley 560 so as to rotate along a rotational trajectory in a substantially vertical plane.

In FIG. 1, a reference numeral 570 denotes a tension pulley for applying tension to the pump-side endless belt 565.

In the present embodiment, the pump-side transmission mechanism 550 is embodied as a pulley transmission mechanism as described earlier. Needless to say, in place of the above-described configuration, it is possible to operatively connect the output shaft 61 with the input shaft 105 via a shaft transmission mechanism.

In the present embodiment, as shown in FIG. 3, the input shaft 105 is separate from the first pump shaft 120(1) and the second pump shaft 120(2).

Thus, the gear transmission mechanism 130 has a driving gear 131 that is supported by the input shaft 105 in a relatively non-rotatable manner, and first and second gears 132(1), 132(2) that are supported in a relatively non-rotatable manner by the first and second pump shafts 120(1), 120(2), respectively, in a state of being operatively engaged with the driving gear 131.

In place of the above configuration, one of the first and second pump shafts 120(1), 120(2) can be utilized as the input shaft 105.

That is, a first end of any one of the first and second pump shafts 120(1), 120(2) may be extended outwards from the pump case 150A so as to function as the input end.

Both the first and second hydraulic pump main bodies 110(1), 110(2) are of an axial piston type including a pump-side cylinder block (not shown) that is supported in a relatively non-rotatable manner by the corresponding pump shaft 120(1), 120(2) and a plurality of pump-side pistons (not shown) that are accommodated in the pump-side cylinder block in a reciprocating manner and in a relatively non-rotatable manner around the axis line.

In the present embodiment, as described earlier, the first and second hydraulic pump main bodies 110(1), 110(2) are of the variable displacement type.

Accordingly, as shown in FIG. 3, in addition to the above-described configuration, the hydraulic pump unit 100A includes first and second output adjusting members 140(1), 140(2) that vary suction/discharge amount of the first and second hydraulic pump main bodies 110(1), 110(2), respectively.

The first and second output adjusting members 140(1), 140(2) may each have a movable swash plate that is engaged directly or indirectly with free ends of the corresponding pump-side pistons to define a reciprocating range of the pump-side pistons, and an control shaft that slants the movable swash plate based on an operation from outside.

In the present embodiment, the movable swash plate is configured so as to slant over a rearward area and a forward area that are divided by a neutral position where the suction/discharge amount of the corresponding hydraulic pump main body is set to substantially zero.

Specifically, the movable swash plate of the first output adjusting member 140(1) is placed at the neutral position in a case where the control shaft is placed at a reference position around the axis line, is slanted toward the rearward area where the first hydraulic pump main body 110(1) sucks hydraulic fluid from the forward-movement high-pressure-side first HST line 600(1)(F) and discharges the hydraulic fluid to the rearward-movement high-pressure-side first HST line 600(1)(R) in a case where the control shaft is rotated from the reference position in a rearward direction around the axis line, and is slanted toward the forward area where the first hydraulic pump main body 110(1) sucks hydraulic fluid from the rearward-movement high-pressure-side first HST line 600(1)(R) and discharges the hydraulic fluid to the forward-movement high-pressure-side first HST line 600(1)(F) in a case where the control shaft is rotated from the reference position in a forward direction around the axis line.

Similarly, the movable swash plate of the second output adjusting member 140(2) can be slanted toward both of the forward area and the rearward area that are divided by the neutral position.

The control shafts of the first and second output adjusting members 40(1), 140(2) are controlled via a steering/speed-changing control mechanism 700, that is to be described in detail later, in accordance with manipulation with manual operation on the steering operation member 70 and the speed-change operation member 75.

As shown in FIG. 3, the hydraulic pump unit 100A further includes an auxiliary pump main body 180 that is driven by one (the first pump shaft 120(1) in the present embodiment) of the first and second pump shafts 120(1), 120(2).

As shown in FIG. 3, the auxiliary pump main body 180 can function as a charge fluid source for the first and second HSTs and a hydraulic pressure source for a hydraulic lifting device (not shown) that lifts up and down the mower 30, as well as a hydraulic pressure source for first and second actuators 730(1), 730(2) in a case where the first and second actuators 730(1), 730(2) are provided as hydraulic actuators.

Described below are fluid channels formed in the pump case 150A.

As shown in FIG. 3, the pump case 150A is formed with a pair of first-pump hydraulic fluid channels 610(1) that configure a part of the pair of first HST lines 600(1), and a pair of second-pump hydraulic fluid channels 610(2) that configure a part of the pair of second HST lines 600(2). The pair of first-pump hydraulic fluid channels 610(1) include a forward-movement high-pressure-side first-pump hydraulic fluid channel 610(1)(F) that is highly pressurized at the forward movement of the vehicle, and a rearward-movement high-pressure-side first-pump hydraulic fluid channel 610(1)(R) that is highly pressurized at the rearward movement of the vehicle. The pair of second-pump hydraulic fluid channels 610(2) include a forward-movement high-pressure-side second-pump hydraulic fluid channel 610(2)(F) that is highly pressurized at the forward movement of the vehicle, and a rearward-movement high-pressure-side second-pump hydraulic fluid channel 610(2)(R) that is highly pressurized at the rearward movement of the vehicle.

The pair of first-pump hydraulic fluid channels 610(1) has first ends fluidly connected to the first hydraulic pump main body 110(1) and second ends opened to an outer surface of the pump case 150A so as to form a pair of first-pump hydraulic fluid ports 610P(1).

The pair of second-pump hydraulic fluid channels 610(2) has first ends fluidly connected to the second hydraulic pump main body 110(2) and second ends opened to the outer surface so as to form a pair of second-pump hydraulic fluid ports 610P(2).

As shown in FIG. 2, in the present embodiment, the pump case 150A has a hollow pump case main body 160 formed with an opening that allows the first and second hydraulic pump main bodies 110(2) to be passed therethrough, and a pump-side port block 170 that is detachably connected to the pump case main body 160 so as to liquid-tightly seal the opening. The first and second hydraulic pump main bodies 110(1), 110(2) are accommodated in a pump space defined by the pump case main body 160 and the pump-side port block 170.

The pair of first-pump hydraulic fluid channels 610(1) and the pair of second-pump hydraulic fluid channels 610(2) are formed in the pump-side port block 170.

Specifically, the pump-side port block 170 has a pump surface which faces the pump space and with which the first and second hydraulic pump main bodies are brought into contact in a sliding manner around the axis line.

The first ends of the pair of first-pump hydraulic fluid channels 610(1) are opened to the pump surface so as to be fluidly connected to the first hydraulic pump main body 110(1) via a pair of first pump ports such as kidney ports. The second ends of the pair of first-pump hydraulic fluid channels 610(1) are opened to an outer surface of the pump-side port block so as to form the pair of first-pump hydraulic fluid ports 610P(1).

Similarly, the first ends of the pair of second-pump hydraulic fluid channels 610(2) are opened to the pump surface so as to be fluidly connected to the second hydraulic pump main body 110(2) via a pair of second pump ports such as kidney ports. The second ends of the pair of second-pump hydraulic fluid channels 610(2) are opened to the outer surface so as to form the pair of second-pump hydraulic fluid ports 610P(2).

As shown in FIG. 3, the pump case 150A is further provided with a suction fluid channel 625, a discharge fluid channel 630, a first-HST charge fluid channel 640(1), a second-HST charge fluid channel 640(2), a first-HST bypass fluid channel 650(1), a second-HST bypass fluid channel 650(2), and a hydraulic pressure setting fluid channel 660. The suction fluid channel 625 has a first end opened to the outer surface so as to form a suction port 625P, and a second end fluidly connected to a suction part of the auxiliary pump main body 180. The discharge fluid channel 630 has a first end fluidly connected to a discharge part of the auxiliary pump main body 180. The first-HST charge fluid channel 640(1) has a first end fluidly connected to the discharge fluid channel 630 and second ends fluidly connected the pair of first-pump hydraulic fluid channels 610(1) via check valves 635, respectively. The second-HST charge fluid channel 640(2) has a first end fluidly connected to the discharge fluid channel 630 and second ends fluidly connected the pair of second-pump hydraulic fluid channels 610(2) via check valves 635, respectively. The first-HST bypass fluid channel 650(1) fluidly connects between the pair of first-pump hydraulic fluid channels 610(1), and is selectively communicated or blocked by an externally operated first-HST bypass valve 655(1). The second-HST bypass fluid channel 650(2) fluidly connects between the pair of second-pump hydraulic fluid channels 610(2), and is selectively communicated or blocked by an externally operated second-HST bypass valve 655(2). The hydraulic pressure setting fluid channel 660 has a first end fluidly connected to the discharge fluid channel 630 and a second end fluidly connected to the suction fluid channel 625, and has a relief valve 665 that is inserted therein so as to set hydraulic pressure of the discharge fluid channel 630.

The suction port 625P is fluidly connected to a fluid source such as a reservoir tank 622, which is included in the working vehicle 1A, via a suction conduit 620 having a filter 621 inserted therein.

As described earlier, the first and second hydraulic motor main bodies 210(1), 210(2) are disposed in the vicinity of the corresponding left and right driving wheels 20L, 20R so as to secure the free space as large as possible between the pair of left and right driving wheels 20L, 20R.

In the present embodiment, the first and second hydraulic motor main bodies 210(1), 210(2) are incorporated in a first wheel motor device 400A(1) that drives the left driving wheel 20L and a second wheel motor device 400A(2) that drives the right driving wheel 20R, respectively.

Specifically, the working vehicle 1A according to the present embodiment has the first wheel motor device 400A(1) including the first hydraulic motor main body 210(1) and the second wheel motor device 400A(2) including the second hydraulic motor main body 210(2).

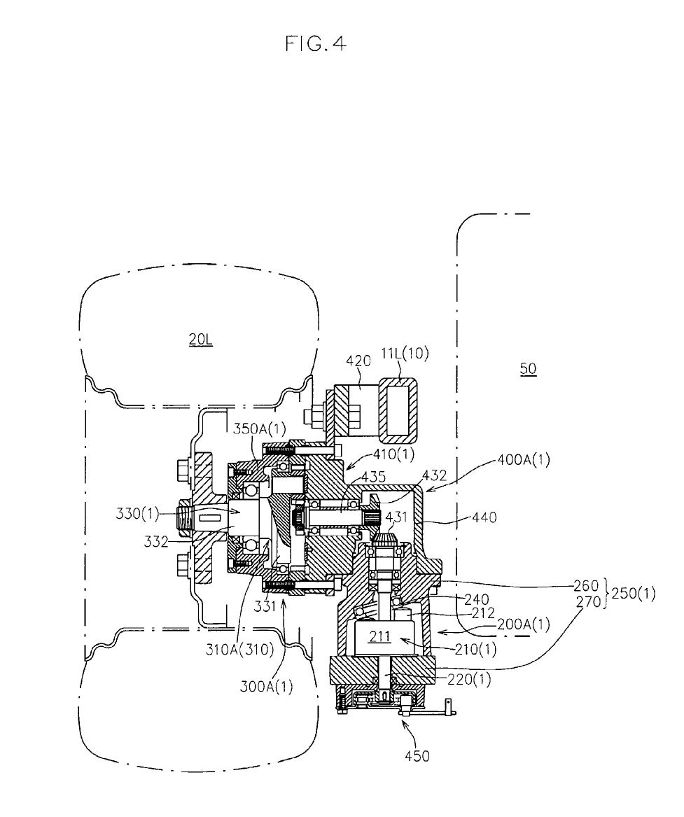

FIG. 4 is a vertical cross-sectional expanded view of the first wheel motor device 400A(1), taken along line IV-IV in FIG. 2.

It should be noted that the second wheel motor device 400A(2) has a configuration substantially identical to that of the first wheel motor device 400A(1), and is disposed symmetrically with the first wheel motor device 400A(1) with a virtual central surface, which runs through the center in the vehicle widthwise direction, as a reference.

Therefore, the following description is made mainly on the first wheel motor device 400A(1), and the same reference numerals or the same reference numerals with replacing the parenthetical (1) with (2) are denoted for the same components of the second wheel motor device 400A(2) as those of the first wheel motor device 400A(1) to omit the description of the second wheel motor device 400A(2).

As shown in FIG. 4, the first wheel motor device 400A(1) includes the first hydraulic motor main body 210(1), a deceleration mechanism 310 that decelerates rotational power output from the first hydraulic motor main body 210(1), a first output member 330(1) that outputs the rotational power decelerated by the deceleration mechanism 310 to the corresponding left driving wheel 20L, and a first housing 410(1) that accommodates the first hydraulic motor main body 210(1) and the deceleration mechanism 310, supports the first output member 330(1), and is supported by the vehicle frame 10 via a mounting bracket 420 or the like.

In the present embodiment, the first wheel motor device 400A(1) is formed by a first hydraulic motor unit 200A(1) including the first hydraulic motor main body 210(1), and a first deceleration unit 300A(1) that includes the deceleration mechanism 310 and the first output member 330(1) and that is substantially accommodated within a rim of the driving wheel.

As shown in FIG. 4, the first hydraulic motor unit 200A(1) includes, in addition to the first hydraulic motor main body 210(1), a first motor shaft 220(1) supporting the first hydraulic motor main body 210(1) in a relatively non-rotatable manner, and a first motor case 250(1) that accommodates the first hydraulic motor main body 210(1) and supports the first motor shaft 220(1) in a rotatable manner about the axis line.

The first hydraulic motor main body 210(1) is of the axial piston type, and has a motor-side cylinder block 211 that is supported in a relatively non-rotatable manner by the first motor shaft 220(1), and a plurality of motor-side pistons 212 that are accommodated in the motor cylinder block 211 in a reciprocating manner along the axis line and in a relatively non-rotatable manner around the axis line.

In the present embodiment, as described earlier, the first and second hydraulic motor main bodies 210(1), 210(2) are of the fixed displacement type.

Accordingly, as shown in FIG. 4, the first hydraulic motor unit 200A(1) includes, in addition to the above configuration, a fixed swash plate 240 that defines a reciprocating range of the motor-side pistons 212.

The first housing 410(1) is configured by the first motor case 250(1) and a first gear case 350A(1) that is to be described later.

As shown in FIG. 3, the first motor case 250(1) is provided with a pair of first-motor hydraulic fluid channels 670(1) that configure a part of the pair of first HST lines 600(1). The pair of first-motor hydraulic fluid channels 670(1) includes a forward-movement high-pressure-side first-motor hydraulic fluid channel 670(1)(F) that is highly pressurized at the forward movement of the vehicle and a rearward-movement high-pressure-side first-motor hydraulic fluid channel 670(1)(R) that is highly pressurized at the rearward movement of the vehicle.

The pair of first-motor hydraulic fluid channels 670(1) have first ends fluidly connected to the first hydraulic motor main body 210(1) and second ends opened to an outer surface of the first motor case 250(1) so as to form a pair of first-motor hydraulic fluid ports 670P(1).

The forward-movement high-pressure-side first-motor hydraulic fluid channel 670(1)(F) is fluidly connected to the forward-movement high-pressure-side first-pump hydraulic fluid channel 610(1)(F) via a forward-movement high-pressure-side first HST conduit 680(1)(F) that is highly pressurized at the forward movement of the vehicle. The rearward-movement high-pressure-side first-motor hydraulic fluid channel 670(1)(R) is fluidly connected to the rearward-movement high-pressure-side first-pump hydraulic fluid channel 610(1)(R) via a rearward-movement high-pressure-side first HST conduit 680(1)(R) that is highly pressurized at the rearward movement of the vehicle.

As shown in FIG. 4, in the present embodiment, the first motor case 250(1) has a hollow first motor case main body 260 formed with an opening that allows the first hydraulic motor main body 210(1) to be passed therethrough, and a first-motor-side port block 270 detachably connected to the first motor case main body 260 so as to liquid-tightly seal the opening. The first hydraulic motor main body 210(1) is accommodated in a first motor space that is defined by the first motor case main body 260 and the first-motor-side port block 270.

The pair of first-motor hydraulic fluid channels 670(1) are formed in the first-motor-side port block 270.

Specifically, the first-motor-side port block 270 has a motor surface which faces the first motor space and with which the first hydraulic motor main body 210(1) is brought into contact in a sliding manner around the axis line.

The first ends of the pair of first-motor hydraulic fluid channels 670(1) are opened to the motor surface so as to be fluidly connected to the first hydraulic motor main body 210(1) via a pair of motor ports such as kidney ports. The second ends of the pair of first-motor hydraulic fluid channels 670(1) are opened to the outer surface of the first-motor-side port block so as to form the pair of first-motor hydraulic fluid ports 670P(1).

The first motor shaft 220(1) is supported in a rotatable manner around the axis line by the first motor case 250(1) in a state of having a first end that extends outwards from the first motor case 250(1) so as to output rotational power to the deceleration mechanism 310.

The first deceleration unit 300A(1) has the deceleration mechanism 310 operatively connected to the first motor shaft 220(1), the first output member 330(1), and the first gear case 350A(1) that accommodates the deceleration mechanism 310, supports the first output member 330(1) in a rotatable manner around the axis line, and is connected to the first motor case 250(1).

The first and second hydraulic motor main bodies 210(1), 210(2) may be formed to have a volume larger than the first and second hydraulic pump main bodies 110(1), 110(2) so as to achieve hydraulic deceleration that bears a part of a deceleration ratio of the deceleration mechanism 310.

In the present embodiment, the deceleration mechanism 310 has a planetary gear mechanism 310A.

The planetary gear mechanism 310A includes a sun gear operatively connected to the first motor shaft 220(1), planetary gears engaged with the sun gear so as to rotate around the sun gear, carriers that supports the planetary gears in a relatively rotatable manner and rotates around the sun gear in accordance with rotation of the planetary gears, and an internal gear engaged with the planetary gears.

As shown in FIG. 4, the first output member 330(1) has a flange part 331 that is connected to the carriers so as to rotate about the axis line in accordance with rotation of the carrier around the sun gear, and an output shaft part 332 that extends outwards in the vehicle widthwise direction from the flange part 331 so as to be connected to the corresponding left driving wheel 20L.

In the present embodiment, the first gear case 350A(1) is disposed such that the output shaft part 332 is positioned coaxially with a rotational axis of the corresponding left driving wheel 20L.

On the other hand, the first motor case 250(1) is fixed to the first gear case 350A(1) at an arbitrary position around the rotational axis in a range not to interfere with the vehicle frame 10 in a state where the first motor shaft 220(1) is substantially orthogonal to the rotational axis.

Specifically, the first wheel motor device 400A(1) has, in addition to the above configuration, a driving bevel gear 431 supported by the first end of the first motor shaft 220(1) in a relatively non-rotatable manner, an intermediate shaft 435 supporting the sun gear in a relatively non-rotatable manner, and a driven bevel gear 432 supported by the intermediate shaft 435 in a relatively non-rotatable manner while being engaged with the driving bevel gear 431.

According to the above configuration, the first motor case 250(1) can be connected to the first gear case 35 0A(1) at an arbitrary position around the rotational axis of the left driving wheel 20L while maintaining a power transmission state from the first motor shaft 220(1) to the sun gear.

Accordingly, it is possible to place in a desired orientation the pair of first-motor hydraulic fluid ports 670P(1) that are fluidly connected to the pair of first-pump hydraulic fluid ports 610P(1) via the pair of HST conduits 680(1), thereby achieving effective layout of the pair of HST conduits 680(1).

The driving bevel gear 431 and the driven bevel gear 432 may be covered with a cover 440 formed integrally with one of the first motor case 250(1) and the first gear case 350A(1) or a cover formed separately from the first motor case 250(1) and the first gear case 350A(1).

As shown in FIG. 4, in the present embodiment, the cover 440 is formed integrally with the first gear case 350A(1).

In the present embodiment shown in FIG. 4, the first wheel motor device 400A(1) is further provided with a brake unit 450.

The brake unit 450 is configured so as to apply braking power to the first motor shaft 220(1) before being decelerated by the deceleration mechanism 310.

Specifically, as shown in FIG. 4, not only the first end but also another second end of the first motor shaft 220(1) extends outwards from the first motor case 250(1).

The brake unit 450 is attached to the first hydraulic motor unit 200A(1) so as to selectively apply braking power to the second end of the first motor shaft 220(1) in accordance with external operation.

In the present embodiment, the brake unit 450 has an internal expanding drum brake that is accommodated in a brake case. Alternatively, the brake unit 450 may have a band brake in which a drum-shaped brake rotor is exposed outside, or a disk brake.

Needless to say, the working vehicle according to the present invention can include, in place of the first and second wheel motor devices 400A(1), 400A(2), first and second wheel motor devices of another type.

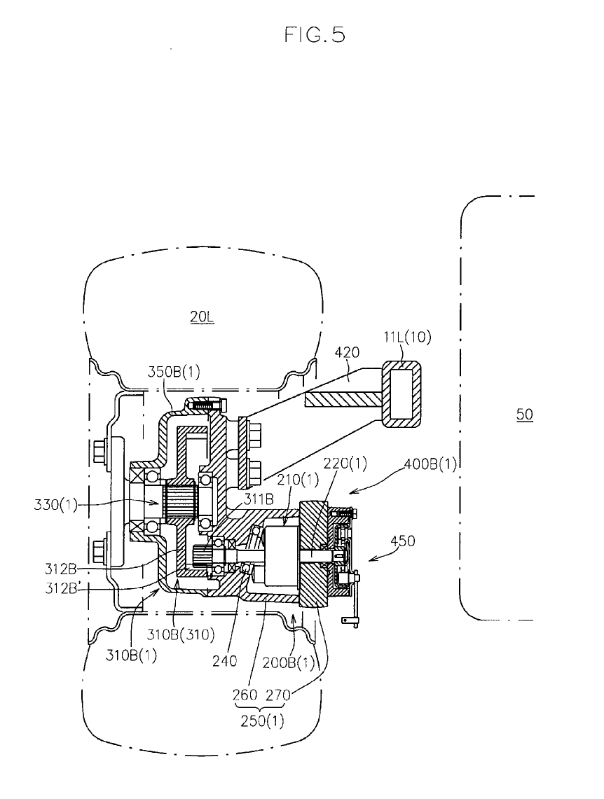

FIG. 5 shows a vertical cross-sectional expanded view of a first wheel motor device 400B(1) according to a first modified example.

As shown in FIG. 5, the first wheel motor device 400B(1) includes an internal gear mechanism 310B that functions as the deceleration mechanism 310, in place of the planetary gear mechanism 310A.

Specifically, the first wheel motor device 400B(1) includes a first hydraulic motor unit 200B(1) having a configuration substantially identical to that of the first hydraulic motor unit 200A(1), and a first deceleration unit 300B(1) having the internal gear mechanism 310B.

As shown in FIG. 5, the first hydraulic motor unit 200B(1) is connected to the first deceleration unit 300B(1) in a state where the first motor shaft 220(1) is displaced from the rotational axis of the corresponding left driving wheel 20L while being parallel thereto.

The first deceleration unit 300B(1) has the internal gear mechanism 310B that receives rotational power from the first motor shaft 220(1), the first output member 330(1) that outputs the rotational power decelerated by the internal gear mechanism 310B to the corresponding left driving wheel 20L, and a first gear case 350B(1) that accommodates the internal gear mechanism 310B and supports the first output member 330(1) in a rotatable manner about the axis line.

The internal gear mechanism 310B has a driving gear 31 1B supported by the first end of the first motor shaft 220(1) in a relatively non-rotatable manner, and a driven member 312B that is supported by the first output member 330(1) in a relatively non-rotatable manner and that is provided with an internal gear 312B′ engaged with the driving gear 311B.

In the first wheel motor device 400B(1) according to the first modified example shown in FIG. 5, the first hydraulic motor unit 200B(1) is preferably configured so as to be connected to the first deceleration unit 300B(1) at an arbitrary position around the first output member 330(1).

The above-described configuration could achieve effective layout of the HST conduits 680(1).

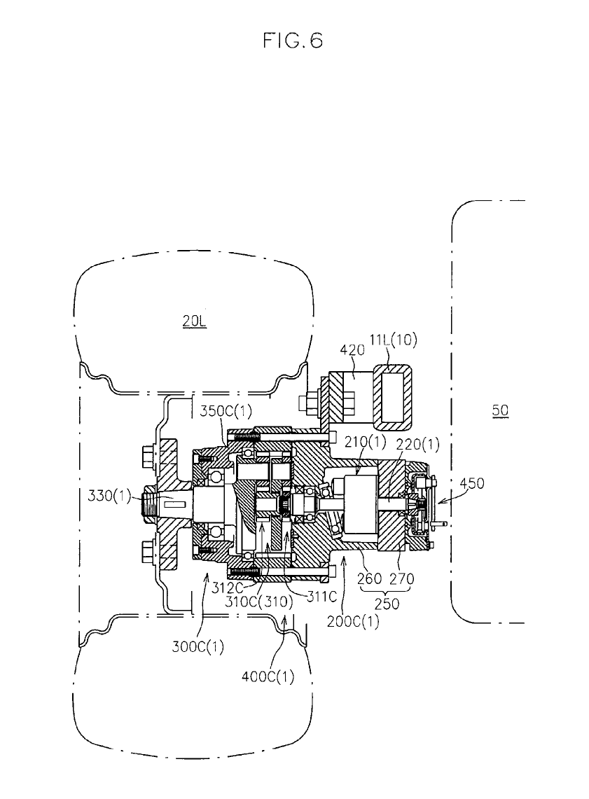

FIG. 6 is a vertical cross-sectional expanded view of a first wheel motor device 400C(1) according to a second modified example.

As shown in FIG. 6, the first wheel motor device 400C(1) includes, as the deceleration mechanism 310, a planetary gear mechanism 310C having first and second planetary gear mechanisms 311C, 312C that are disposed in series to each other.

Specifically, the first wheel motor device 400C(1) includes a first hydraulic motor unit 200C(1) that has a configuration substantially identical to those of the first hydraulic motor units 200A(1), 200B(1), and a first deceleration unit 300C(1) including the planetary gear mechanism 310C.

As shown in FIG. 6, the first hydraulic motor unit 200C(1) is connected to the first deceleration unit 300C(1) such that the first motor shaft 220(1) is positioned coaxially with the rotational axis of the corresponding left driving wheel 20L.

The first deceleration unit 300C(1) has the first planetary gear mechanism 311C that receives rotational power from the first motor shaft 220(1), the second planetary gear mechanism 312C that receives the rotational power decelerated by the first planetary gear mechanism 311C, the first output member 330(1) that outputs the rotational power decelerated by the second planetary gear mechanism 312C to the corresponding left driving wheel 20L, and a first gear case 350C(1) that accommodates the first and second planetary gear mechanisms 311C, 312C and supports the first output member 330(1) in a rotatable manner about the axis line.

In the first wheel motor device 400C(1) according to the second modified example shown in FIG. 6, the first hydraulic motor unit 200C(1) is preferably configured so as to be connected to the first deceleration unit 300C(1) at an arbitrary position around the axis line of the corresponding left driving wheel 20L.

The above configuration could achieve effective layout of the HST conduits 680(1).

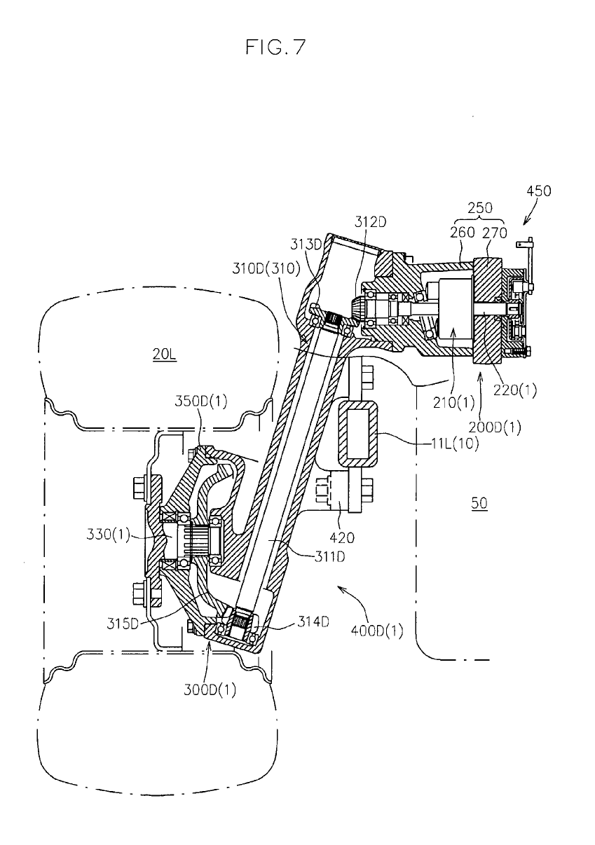

FIG. 7 is a vertical cross-sectional expanded view of a first wheel motor device 400D(1) according to a third modified example.

As shown in FIG. 7, the first wheel motor device 400D(1) includes, as the deceleration mechanism 310, a bevel gear mechanism 310D.

Specifically, the first wheel motor device 400D(1) includes a first hydraulic motor unit 200D(1) that has a configuration substantially identical to those of the first hydraulic motor units 200A(1), 200B(1), 200C(1), and a first deceleration unit 300D(1) including the bevel gear mechanism 310D.

As shown in FIG. 7, the first hydraulic motor unit 200D(1) is connected to the first deceleration unit 300D(1) in a state where the first motor shaft 220(1) is placed at a desired position in a virtual plane that is displaced upwards from the rotational axis of the corresponding left driving wheel 20L while being parallel thereto. In the present third modified example, the first hydraulic motor unit 200D(1) is disposed above the corresponding left main frame 11L.

The first deceleration unit 300D(1) has the bevel gear mechanism 310D that decelerates rotational power transmitted from the first motor shaft 220(1), the first output member 330(1) that outputs the rotational power decelerated by the bevel gear mechanism 310D to the corresponding left driving wheel 20L, and a first gear case 350D(1) that accommodates the bevel gear mechanism 310D and that supports the first output member 330(1) in a rotatable manner about the axis line.

As shown in FIG. 7, the bevel gear mechanism 310D has an intermediate shaft 311D supported by the first gear case 350D(1) in a rotatable manner about the axis line while being aligned along the substantially vertical direction, a first driving bevel gear 312D supported by the first end of the first motor shaft 220(1) in a relatively non-rotatable manner, a first driven bevel gear 313D supported by an upper end of the intermediate shaft 311D in a relatively non-rotatable manner in a state of being engaged with the first driving bevel gear 312D, a second driving bevel gear 314D supported by a lower end of the intermediate shaft 311D in a relatively non-rotatable manner, and a second driven bevel gear 315D supported by the first output member 330(1) in a relatively non-rotatable manner in a state of being engaged with the second driving bevel gear 314D.

The first driving bevel gear 312D and the first driven bevel gear 313D configure a first deceleration bevel gear train, while the second driving bevel gear 314D and the second driven bevel gear 315D configure a second deceleration bevel gear train.

In the first wheel motor device 400D(1) according to the third modified example shown in FIG. 7, the first hydraulic motor unit 200D(1) is preferably configured so as to be connected to the first deceleration unit 300D(1) such that the axis line of the first motor shaft 220(1) is aligned along the vehicle lengthwise direction.

The described-above configuration could achieve effective layout of the HST conduits 680(1) as well as improved workability in maintenance of the first hydraulic motor main body 210(1).

It should be noted that the first and second hydraulic pump main bodies 110(1), 110(2) as well as the first and second hydraulic motor main bodies 210(1), 210(2) are not limited to the axial piston type, but it is possible to employ various types such as a radial piston type, a gerotor type, and the like.

As described earlier, in the working vehicle 1A according to the present embodiment, it is possible to dispose, independently from the first and second hydraulic motor main bodies 210(1), 210(2), the first and second hydraulic pump main bodies 110(1), 110(2) that receive rotational power from the driving power source 60 via the pump-side transmission mechanism 550. Therefore, the first and second hydraulic pump main bodies 110(1), 110(2) can be disposed at a desired position that realizes simplification in the configuration of the pump-side transmission mechanism 550.

Further, the first hydraulic motor main body 210(1) that outputs rotational power to the left driving wheel 20L can be disposed independently in the vicinity of the left driving wheel 20L while being fluidly connected to the hydraulic pump main body 110 (1) via the pair of first HST conduits 680(1).

Similarly, the second hydraulic motor main body 210(2) that outputs rotational power to the right driving wheel 20R can be disposed independently in the vicinity of the right driving wheel 20R while being fluidly connected to the second hydraulic pump main body 110(2) via the pair of second HST conduits 680(2).

Specifically, the working vehicle 1A according to the present embodiment thus configured can secure, between the pair of left and right driving wheels 20L, 20R, a free space as large as possible in which there is provided no traveling mechanical transmission mechanism.

The working vehicle 1A utilizes the free space as a space for installing the discharge duct 50.

As described above, the arrangement of the discharge duct 50 in the free space that is secured between the first and second hydraulic motor main bodies 210(1), 210(2) makes it possible to improve design freedom of the discharge duct 50, thereby eliminating the use of or downsizing a blower, which has been needed in the conventional art. In one conventional configuration in which a mechanical differential gear mechanism is inserted in a traveling transmission path, or another conventional configuration in which there is disposed in the center in the vehicle widthwise direction an HST unit having a hydraulic pump main body and a hydraulic motor main body accommodated in one HST housing, the discharge duct needs to be designed so as not to interfere with the axle housing that accommodates the mechanical differential gear mechanism, the HST unit, and power transmission members therefore, resulting in that the discharge duct is required to have a steeply inclined part or a vertical part.

On the contrary, in the working vehicle 1A according to the present embodiment, the discharge duct 50 is disposed in the free space that is secured as large as possible in a state that no traveling mechanical transmission mechanism is disposed therein.

Therefore, the discharge duct 50 is allowed to have such a substantially straight shape that enables mown grass to be smoothly conveyed from the mower 30 to the container 40 without being disturbed by the axle housing and the HST unit. Thus, the present embodiment could eliminate the use of or downsize the blower, which has been needed in the conventional configuration.

The working vehicle 1A according to the present embodiment further includes the following configuration in order to prevent the PTO-side transmission mechanism 500 from deteriorating design freedom for the discharge duct 50.

As described in FIG. 2, the PTO-side transmission mechanism 500 is configured to transmit power from the driving power source 60 to the mower 30 via a PTO-side power transmission member 510 that extends in the vehicle lengthwise direction in one of a left space 90L provided in plan view between the left main frame 11L and the discharge duct 50 and a right space 90R provided in plan view between the right main frame 11R and the discharge duct 50 (the left space 90L in the present embodiment).

The above configuration of the PTO-side transmission mechanism 500 effectively prevents deterioration in design freedom for the discharge duct 50.

As shown in FIGS. 1 and 2, the PTO-side transmission mechanism 500 in the present embodiment has a pulley transmission mechanism 500A.

The pulley transmission mechanism 500A includes a PTO-side driving pulley 501A supported in a relatively non-rotatable manner by the output shaft 61 of the driving power source 60 extending outwards in the vehicle widthwise direction in a state of being along the substantially horizontal direction, a PTO-side driven pulley 502A supported in a relatively non-rotatable manner by an input shaft 31 of the mower 30, and an endless belt 510A that is wound around the PTO-side driving pulley 501A and the PTO-side driven pulley 502A so as to rotate along a rotational trajectory in a substantially vertical surface and that functions as the PTO-side power transmission member 510.

The above configuration makes it possible to enlarge a width of the discharge duct 50 as much as possible within a space between the pair of left and right main frames 11L, 11R while achieving power transmission from the driving power source 60 to the mower 30.

A reference numeral 505A in FIGS. 1 and 2 denotes a tension pulley 505A for applying tension to the endless belt 510A.

The working vehicle 1A according to the present embodiment includes the pulley transmission mechanism 500A as the PTO-side transmission mechanism 500. However, needles to say, the present invention is not limited thereto.

Alternatively, there can be provided a shaft transmission mechanism 500B in place of the pulley transmission mechanism 500A, which functions as the PTO-side transmission mechanism 500.

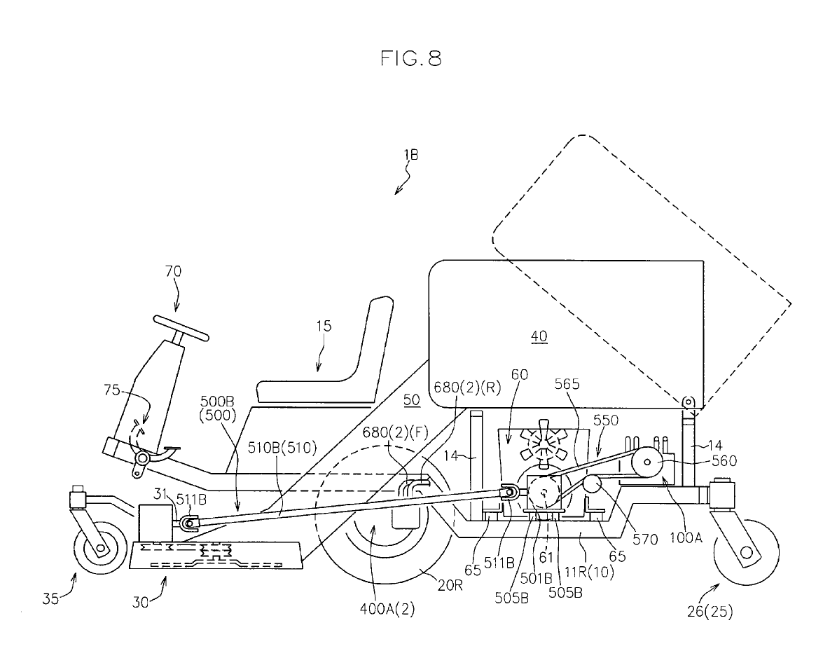

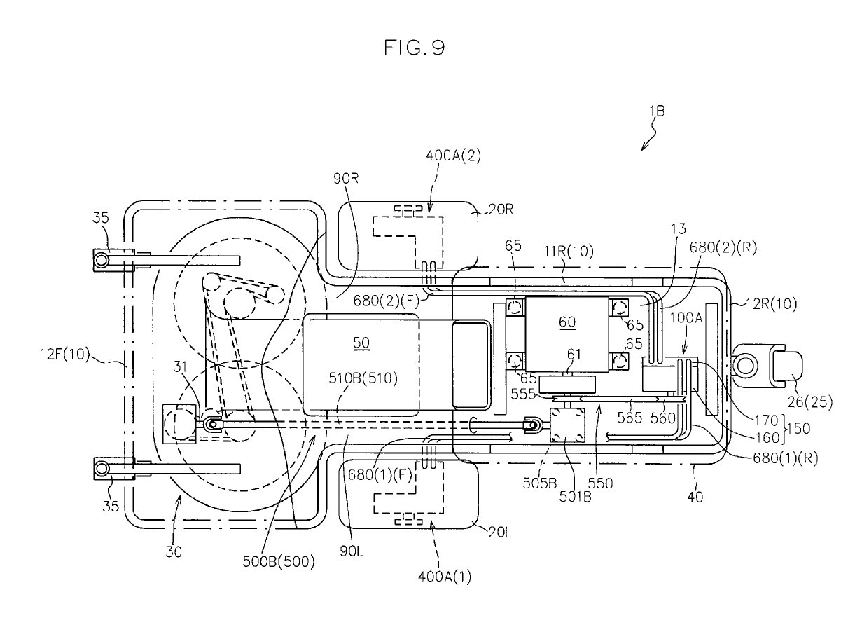

FIGS. 8 and 9 are a side view and a plan view, respectively, of a working vehicle 1B according to a first modified example of the present embodiment, that includes the shaft transmission mechanism 500B functioning as the PTO-side transmission mechanism 500.

As shown in FIGS. 8 and 9, the shaft transmission mechanism 500B has a PTO-side transmission shaft 510B that functions as the PTO-side power transmission member 510 and that is provided at both ends with universal joints 511B.

In the working vehicle 1B shown in FIGS. 8 and 9, the output shaft 61 of the driving power source 60 extends outwards in the vehicle widthwise direction in a state of being along the substantially horizontal direction, similarly to the working vehicle 1A shown in FIGS. 1 and 2.

Accordingly, the shaft transmission mechanism 500B includes a gear box 501B in which an input part is directed inwards in the vehicle width direction so as to be operatively connected to the output shaft 61 of the driving power source 60 and an output part is directed forwards, and the PTO-side transmission shaft 510B that extends in the vehicle lengthwise direction in one of the left space 90L and the right space 90R (the left space 90L according to the example shown in FIGS. 8 and 9) so as to connect between the output part of the gear box 501B and the input shaft 31 of the mower 30.

A reference numeral 505B in FIGS. 8 and 9 denotes vibration-absorbing rubber 505B for supporting the gear box 501B in a vibration-absorbing manner.

The steering/speed-changing control mechanism 700 included in the working vehicle 1A according to the present embodiment will now be described.

The working vehicle 1A according to the present embodiment is configured such that the first and second HSTs are controlled identically with each other in accordance with manual operation on the speed-change operation member 75, and are controlled contradictorily from each other in accordance with manual operation on the steering operation member 70.

In a case where the speed-change operation member 75 is operated by a predetermined amount in one of the forward and rearward directions, the steering/speed-changing control mechanism 700 operates the first and second output adjusting members 140(1), 140(2) such that both of the first and second hydraulic motor main bodies 210(1), 210(2) output driving power having an identical rotation speed corresponding to the predetermined amount in an identical rotation direction corresponding to the operation direction of the speed-change operation member 75. Further, in a case where the single steering operation member 70 such as a round steering wheel is operated by a predetermined amount in one of left and right directions, the steering/speed-changing control mechanism 700 operates the first and second output adjusting members 140(1), 140(2) such that one of the first and second hydraulic motor main bodies 210(1), 210(2) outputs driving power accelerated by a rotation speed corresponding to the predetermined amount while the other outputs driving power decelerated by the rotation speed corresponding to the predetermined amount.

Specifically, as shown in FIG. 3, the steering/speed-changing control mechanism 700 includes a steering sensor 720 that detects a steering operation direction and a steering operation amount of the steering operation member 70, a traveling sensor 725 that detects a traveling operation direction and a speed-change operation amount of the speed-change operation member 75, a first actuator 730(1) that actuates the first output adjusting member 140(1), a second actuator 730(2) that actuates the second output adjusting member 140(2), and a control device 710 that activates the first and second actuators 730(1), 730(2) in accordance with signals transmitted from the steering sensor 720 and the traveling sensor 725.

As shown in FIG. 3, the steering/speed-changing control mechanism 700 preferably includes, in addition to the above configuration, a left driving wheel rotation sensor 735L that detects a rotation speed of the left driving wheel 20L, and a right driving wheel rotation sensor 735R that detects a rotation speed of the right driving wheel 20R, and is configured such that the control device 710 feedback-controls the first and second actuators 730(1), 730(2) in accordance with signals transmitted from the left and right driving wheel rotation sensors 735L, 735R.

The control device 710 stores a speed-change data on the activating amounts of the first and second actuators 730(1), 730(2) with respect to the speed-change operation amount of the speed-change operation member 75.

On receiving a traveling operation direction and a speed-change operation amount from the traveling sensor 725, the control device 710 activates the first and second actuators 730(1), 730(2) in an identical direction corresponding to the traveling operation direction by an identical operation amount that is calculated based on the speed-change operation amount and the speed-change data, so that the first and second HSTs output driving power having an identical rotation speed corresponding to the speed-change operation amount in an identical direction corresponding to the traveling operation direction.

For example, in a case where the speed-change operation member 75 is operated in the forward direction by a predetermined amount, the control device 710 activates the first and second actuators 730(1), 730(2) such that the first and second HSTs output driving power having an identical speed corresponding to the predetermined amount in the forward direction.

The speed-change operation member 75 is provided as a seesaw pedal in the present embodiment (see FIGS. 1 and 3). Alternatively, the speed-change operation member 75 may be of a two-pedal type including dedicated forward and rearward pedals.

The control device 710 further stores a steering data on the activating amount of the first and second actuators 730(1), 730(2) with respect to the operation amount of the steering operation member 70.

On receiving a steering operation direction and a steering operation amount from the steering sensor 720, the control device 710 activates the first and second actuators 730(1), 730(2) such that one of the first and second HSTs corresponding to the operation direction of the steering operation member 70 outputs driving power accelerated by a speed corresponding to the operation amount and the other HST outputs driving power decelerated by a speed corresponding to the operation amount.

For example, when the working vehicle 1A is traveling forwards, the steering operation member 70 is assumed to be operated by a predetermined amount in the right direction.

In this case, the control device 710 activates the first and second actuators 730(1), 730(2) such that the first HST for driving the left driving wheel 20L outputs driving power accelerated by a speed corresponding to the predetermined amount and the second HST for driving the right driving wheel 20R outputs driving power decelerated by a speed corresponding to the predetermined amount.

As described earlier, the working vehicle 1A according to the present embodiment is configured such that the first and second HSTs could output driving power in both regular (forward) and reverse (rearward) directions. Thus, the working vehicle 1A is configured so that the traveling speed as well as the traveling direction is changed by the first and second HSTs.

In the working vehicle that is configured to turn in accordance with the steering operation of the single steering operation member 70 such as a round steering wheel and change traveling direction between forward and rearward directions by switching the rotational directions of the outputs of the first and second HSTs, it is required to prevent occurrence of an inverse steering phenomenon in which the working vehicle turns in a direction inverse to a desired direction at the rearward movement of the vehicle.

In order to prevent such an inverse steering phenomenon, the working vehicle according to the present embodiment includes, as the steering data, a forward steering data that is applied at the forward movement of the vehicle and a rearward steering data that is applied at the rearward movement of the vehicle.

The above characteristic is described by taking, as an example, a case where the working vehicle 1A is turned to right.

The first and second HSTs output driving power accelerated in the forward direction as the control shafts of the first and second output adjusting members 140(1), 140(2) are rotated in one direction about the respective axis lines, and output driving power accelerated in the rearward direction as the control shafts are rotated in the other direction about the respective axis lines.

For example, it is assumed that, in a case where the first actuator 730(1) is in a first operation state, the control shaft of the first output adjusting member 140(1) is rotated in one direction about the axis line so that the first HST is accelerated in the forward direction, and that, in a case where the first actuator 730(1) is in a second operation state, the control shaft of the first output adjusting member 140(1) is rotated in the other direction about the axis line so that the first HST is accelerated in the rearward direction.

Similarly, it is assumed that, in a case where the second actuator 730(2) is in a first operation state, the control shaft of the second output adjusting member 140(2) is rotated in one direction about the axis line so that the second HST is accelerated in the forward direction, and that, in a case where the second actuator 730(2) is in a second operation state, the control shaft of the second output adjusting member 140(2) is rotated in the other direction about the axis line so that the second HST is accelerated in the rearward direction.

In the state assumed as described above, considered is a case where the steering operation member 70 is operated to right in order to turn the working vehicle 1A to right (that is, a case where the first HST for driving the left driving wheel 20L is accelerated and the second HST for driving the right driving wheel 20R is decelerated).

When the working vehicle 1A is traveling forwards, what is required are: in correspondence with the rightward operation of the steering operation member 70, the first actuator 730(1) is brought into the first operation state so that the control shaft of the first output adjusting member 140(1) is rotated in one direction about the axis line, whereby the first HST is accelerated in the forward direction; and the second actuator 730(2) is brought into the second operation state so that the control shaft of the second output adjusting member 140(2) is rotated in the other direction about the axis line, whereby the second HST is decelerated in the forward direction.

On the contrary, when the working vehicle 1A is traveling rearwards, what is required are: in correspondence with the rightward operation of the steering operation member 70, the first actuator 730(1) is brought into the second operation state so that the control shaft of the first output adjusting member 140(1) is rotated in the other direction about the axis line, whereby the first HST is accelerated in the rearward direction; and the second actuator 730(2) is brought into the first operation state so that the control shaft of the second output adjusting member 140(2) is rotated in one direction about the axis line, whereby the second HST is decelerated in the rearward direction.

That is, it is required to set inversely from each other, control on the first actuator 730(1) and the second actuator 730(2) in a case where the steering operation member 70 is operated to one direction of left and right (to right, for example) during the rearward travel and the control on the first actuator 730(1) and the second actuator 730(2) in a case where the steering operation member 70 is operated in the one direction (to right) during the forward travel.

In view of such a requirement, the working vehicle 1A according to the present embodiment has, as the steering data, the forward steering data that is applied at the forward movement of the vehicle and the rearward steering data that is applied at the rearward movement of the vehicle.

The first and second actuators 730(1), 730(2) may be embodied as electric actuators, or hydraulic actuators including an electromagnetic valve and a hydraulic cylinder.

In the case where the first and second actuators 730(1), 730(2) are embodied as the hydraulic actuators, part of pressure fluid discharged from the auxiliary pump main body 180 can be utilized as hydraulic fluid of the hydraulic actuator.

In the working vehicle 1A (see FIGS. 1 and 2) according to the present embodiment and the working vehicle 1B (see FIGS. 8 and 9) according to the first modified example, the driving power source 60 is disposed below the container 40. However, the present invention is not limited to such a configuration.

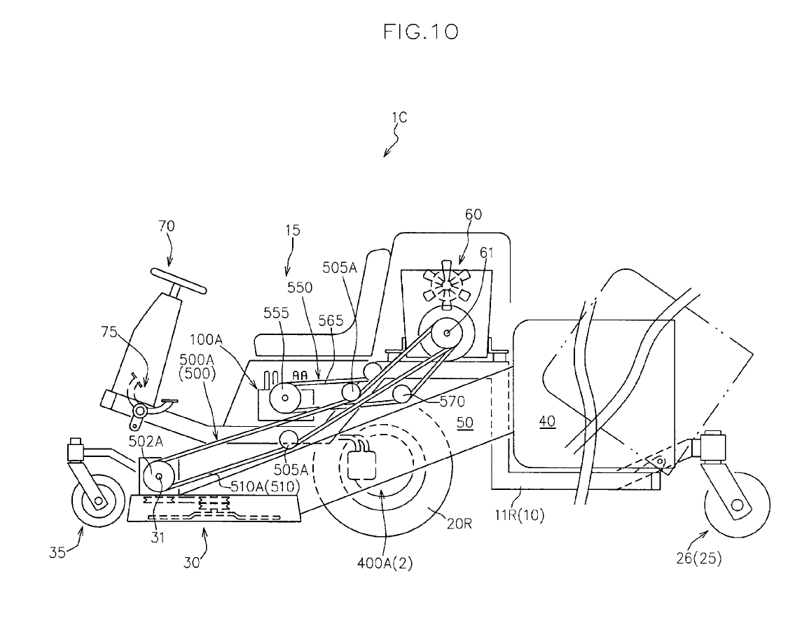

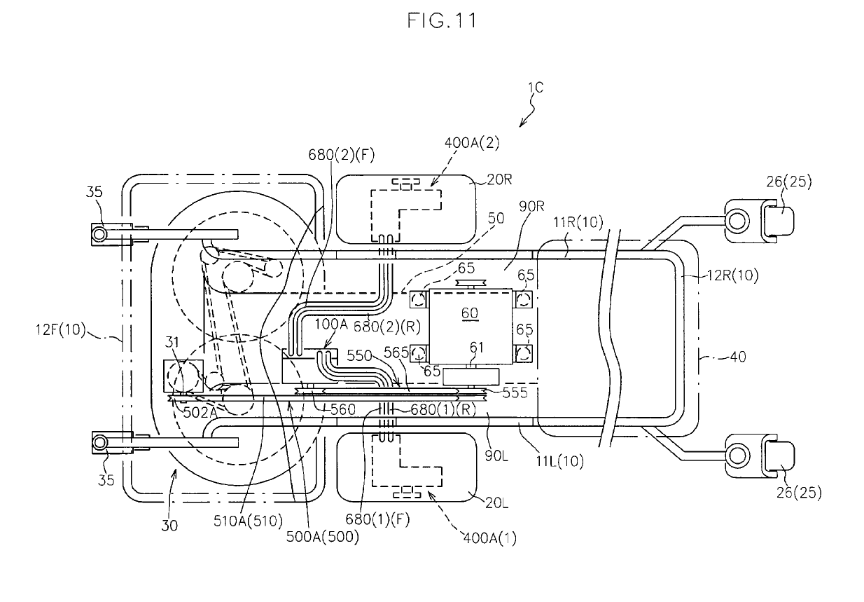

FIGS. 10 and 11 are a side view and a plan view of a working vehicle 1C according to a second modified example.

In the working vehicle 1C according to the second modified example, the driving power source 60 is disposed higher than the pair of left and right driving wheels 20L, 20R, and between the driver's seat 15 and the container 40 in the vehicle lengthwise direction.

The hydraulic pump unit 100A is disposed lower than the driver's seat 15, and forward of the pair of left and right driving wheels 20L, 20R.

### Second Embodiment

Described below with reference to the accompanying drawing is a working vehicle with front-mount mower according to another embodiment of the present invention.

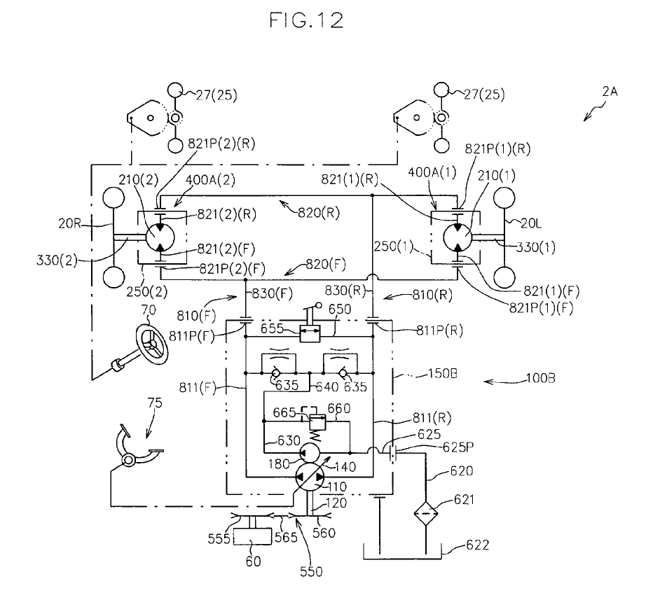

FIG. 12 is a hydraulic circuit diagram of a working vehicle 2A with front-mount mower according to the present embodiment.

It should be noted that, in the drawing, members identical to those of the first embodiment are denoted by identical reference numerals, and description thereof will not be given repeatedly.

The working vehicle 1A according to the first embodiment is configured such that the first and second HSTs are independently controlled from each other and is turned by separately controlling outputs from the first and second HSTs.

On the contrary, the working vehicle 2A according to the present embodiment includes, as the auxiliary wheel 25, steering wheels 27 that are steering-controlled in conjunction with operation of the steering operation member 70, in place of the driven wheel 26. The working vehicle 2A is configured so as to make a turn by steering the steering wheel 27 and to differentially drive the pair of left and right driving wheels 20L, 20R with use of function of hydraulic pressure.

Specifically, in a case where the steering wheel 27 is steered to one direction of left and right, the working vehicle 2A is turned such that one of the pair of driving wheels 20L, 20R on a side corresponding to the one direction is positioned on a side close to a turning center. In this case, the one driving wheel on the side corresponding to the one direction is applied with heavier load according to a steering angle of the steering wheel 27. Thus, the above-described configuration can reduce the rotation speed of the driving wheel on the side corresponding to the one direction and increase the rotation speed of the driving wheel on the other side, resulting in reduction in turning radius.

Specifically, the working vehicle 2A includes a hydraulic pump unit 100B that has a single hydraulic pump main body 110, the first wheel motor device 400A(1) that has the first hydraulic motor main body 210(1), the second wheel motor device 400A(2) that has the second hydraulic motor main body 210(2), and the steering wheels 27 that are steering-controlled by the steering operation member 70, wherein the first and second hydraulic motor main bodies 20(1), 210(2) are fluidly connected in parallel to the single hydraulic pump main body 110.

As shown in FIG. 12, the hydraulic pump unit 100B includes a pump shaft 120 that is operatively connected to the driving power source 60 via the pump-side transmission mechanism 550, the hydraulic pump main body 110 that is supported by the pump shaft 120 in a relatively non-rotatable manner, and a pump case 150B that accommodates the hydraulic pump main body 110 and that supports the pump shaft 120 in a rotatable manner about the axis line.

Similarly to the first and second hydraulic pump main bodies 110(1), 110(2), the hydraulic pump main body 110 is of a variable displacement type.

Therefore, the hydraulic pump unit 100B includes, in addition to the above configuration, an output adjusting member 140 that varies a suction/discharge amount of the hydraulic pump main body 110.

The output adjusting member 140 has a configuration identical to those of the first and second output adjusting members 140(1), 140(2).

A hydraulic circuit of the working vehicle 2A will be now described.

The working vehicle 2A includes a pair of hydraulic motor lines 820 that fluidly connect between the first and second hydraulic motor main bodies 210(1), 210(2) and a pair of hydraulic pump lines 810 that have first ends fluidly connected to the hydraulic pump main body 110. The pair of hydraulic motor lines 820 includes a forward-movement high-pressure-side hydraulic motor line 820(F) that is highly pressurized at the forward movement of the vehicle and a rearward-movement high-pressure-side hydraulic motor line 820(R) that is highly pressurized at the rearward movement of the vehicle. The pair of hydraulic pump lines 810 includes a forward-movement high-pressure-side hydraulic pump line 810(F) that is highly pressurized at the forward movement of the vehicle and a rearward-movement high-pressure-side hydraulic pump line 810(R) that is highly pressurized at the rearward movement of the vehicle.

As shown in FIG. 12, the forward-movement high-pressure-side hydraulic pump line 810(F) has a second end fluidly connected to the forward-movement high-pressure-side hydraulic motor line 820(F), and the rearward-movement high-pressure-side hydraulic pump line 810(R) has a second end fluidly connected to the rearward-movement high-pressure-side hydraulic motor line 820(R).

According to the configuration, the pair of first and second hydraulic motor main bodies 210(1), 210(2) are hydraulically and differentially driven by the hydraulic pump main body 110.

Specifically, the pump case 150B is formed with a forward-movement high-pressure-side pump hydraulic fluid channel 811(F) that configures a part of the forward-movement high-pressure-side hydraulic pump line 810(F), and a rearward-movement high-pressure-side pump hydraulic fluid channel 811(R) that configures a part of the rearward-movement high-pressure-side hydraulic pump line 810(R), as shown in FIG. 12.

The forward-movement high-pressure-side pump hydraulic fluid channel 811(F) has a first end fluidly connected to the hydraulic pump main body 110 via a forward-movement high-pressure-side pump port of the pair of pump port that is highly pressurized at the forward movement of the vehicle, and a second end opened to an outer surface of the pump case so as to form a forward-movement high-pressure-side pump hydraulic fluid port 811P(F).

The rearward-movement high-pressure-side pump hydraulic fluid channel 811(R) has a first end fluidly connected to the hydraulic pump main body 110 via a rearward-movement high-pressure-side pump port of the pair of pump port that is highly pressurized at the rearward movement of the vehicle, and a second end opened to an outer surface of the pump case so as to form a rearward-movement high-pressure-side pump hydraulic fluid port 811P(R).

The first motor case 250(1) of the first wheel motor device 400A(1) is formed with a forward-movement high-pressure-side first-motor hydraulic fluid channel 821(1)(F) that configures a part of the forward-movement high-pressure-side hydraulic motor line 820(F), and a rearward-movement high-pressure-side first-motor hydraulic fluid channel 821(1)(R) that configures a part of the rearward-movement high-pressure-side hydraulic motor line 820(R).

The forward-movement high-pressure-side first-motor hydraulic fluid channel 821(1)(F) has a first end fluidly connected to the first hydraulic motor main body 210(1) via a forward-movement high-pressure-side motor port of the pair of motor ports that is highly pressurized at the forward movement of the vehicle, and a second end opened to an outer surface of the first motor case so as to form a forward-movement high-pressure-side first-motor hydraulic fluid port 821P(1)(F).

The rearward-movement high-pressure-side first-motor hydraulic fluid channel 821(1)(R) has a first end fluidly connected to the first hydraulic motor main body 210(1) via a rearward-movement high-pressure-side motor port of the pair of motor ports that is highly pressurized at the rearward movement of the vehicle, and a second end opened to the outer surface of the first motor case so as to form a rearward-movement high-pressure-side first-motor hydraulic fluid port 821P(1)(R).

Similarly, the second motor case 250(2) of the second wheel motor device 400A(2) is formed with a forward-movement high-pressure-side second-motor hydraulic fluid channel 821(2)(F) that configures a part of the forward-movement high-pressure-side hydraulic motor line 820(F), and a rearward-movement high-pressure-side second-motor hydraulic fluid channel 821(2)(R) that configures a part of the rearward-movement high-pressure-side hydraulic motor line 820(R).

The forward-movement high-pressure-side second-motor hydraulic fluid channel 821(2)(F) has a first end fluidly connected to the second hydraulic motor main body 210(2) via a forward-movement high-pressure-side motor port of the pair of motor ports that is highly pressurized at the forward movement of the vehicle, and a second end opened to an outer surface of the second motor case so as to form a forward-movement high-pressure-side second-motor hydraulic fluid port 82 1P(2)(F).

The rearward-movement high-pressure-side second-motor hydraulic fluid channel 821(2)(R) has a first end fluidly connected to the second hydraulic motor main body 210(2) via a rearward-movement high-pressure-side motor port of the pair of motor ports that is highly pressurized at the rearward movement of the vehicle, and a second end opened to the outer surface of the second motor case so as to form a rearward-movement high-pressure-side second-motor hydraulic fluid port 821P(2)(R).

The forward-movement high-pressure-side first-motor hydraulic fluid port 821P(1)(F) and the forward-movement high-pressure-side second-motor hydraulic fluid port 821P(2)(F) are fluidly connected in parallel to the forward-movement high-pressure-side pump hydraulic fluid port 811P(F) via a forward-movement high-pressure-side conduit 830(F) that is highly pressurized at the forward movement of the vehicle.

Similarly, the rearward-movement high-pressure-side first-motor hydraulic fluid port 821P(1)(R) and the rearward-movement high-pressure-side second-motor hydraulic fluid port 821P(2)(R) are fluidly connected in parallel to the rearward-movement high-pressure-side pump hydraulic fluid port 811 P(R) via a rearward-movement high-pressure-side conduit 830(R) that is highly pressurized at the rearward movement of the vehicle.

In the working vehicle 2A according to the present embodiment, the steering wheel 27 are steering-controlled in correspondence with operation of the steering operation member 70 via a mechanical link mechanism or an electric control mechanism.

The output adjusting member 140 is operated in correspondence with operation of the speed-change operation member 75 via a mechanical link mechanism or an electric control mechanism.

The working vehicle 2A according to the present embodiment includes a pair of steering wheels 27 that are disposed on both sides in the vehicle widthwise direction (see FIG. 12). However, needless to say, the working vehicle 2A may include only one steering wheel 27 in the center in the vehicle widthwise direction.

The present specification is not intended to limit the present invention by the embodiments or the modified examples that has been described above. Various modifications can be made to the working vehicle according to the present invention by those skilled in the art, without departing form the technical scope of the present invention that is defined by the accompanying claims.

What is claimed is:

1. A working vehicle with front-mount mower comprising a vehicle frame that has a pair of left and right main frames extending in a vehicle lengthwise direction, a pair of left and right driving wheels, a mower supported by the vehicle frame on a side forward of the driving wheels, a container supported by the vehicle frame on a side rearward of the driving wheels, a discharge duct that forms a conveyance path used for conveying grass mown by the mower to the container, a driving power source supported by the vehicle frame on a side rearward of the mower, a traveling speed-change device inserted in a traveling transmission path running from the driving power source to the pair of left and right driving wheels, and a PTO-side transmission mechanism that forms a PTO transmission path running from the driving power source to the mower, wherein,
(a) the traveling speed-change device includes a hydraulic pump main body that operatively receives rotational power from the driving power source, a first hydraulic motor main body that forms a first HST for the left driving wheel in cooperation with the hydraulic pump main body, and a second hydraulic motor main body that forms a second HST for the right driving wheel in cooperation with the hydraulic pump main body;
(b) the hydraulic pump main body is independently disposed while being away from the first and second hydraulic motor main bodies;
(c) the first and second hydraulic motor main bodies are disposed independently in the vicinity of the corresponding left and right driving wheels while being away from each other so as to secure a free space between the first and second hydraulic motor main bodies;
(d) the discharge duct is disposed in the free space between the first and second hydraulic motor main bodies in plan view; and
(e) the PTO-side transmission mechanism is configured to transmit rotational power from the driving power source to the mower via a PTO-side power transmission member that extends in the vehicle lengthwise direction within one of a left space provided in plan view between the left main frame and the discharge duct and a right space provided in plan view between the right main frame and the discharge duct.

2. A working vehicle with front-mount mower according to claim 1, wherein the hydraulic pump main body includes a first hydraulic pump main body for the left driving wheel that operatively receives rotational power from the driving power source and that is fluidly connected to the first hydraulic motor main body, and a second hydraulic pump main body for the right driving wheel that operatively receives rotational power from the driving power source and that is fluidly connected to the second hydraulic motor main body.

3. A working vehicle with front-mount mower according to claim 2, further comprising a single pump unit that includes the first and second hydraulic pump main bodies, wherein
the pump unit includes an input shaft operatively connected to the driving power source, the first and second hydraulic pump main bodies operatively connected to the input shaft, and a pump case accommodating the first and second hydraulic pump main bodies and supporting the input shaft, and
the pump case is formed with a pair of first-pump hydraulic fluid channels that have first ends fluidly connected to the first hydraulic pump main body and second ends opened to an outer surface, and a pair of second-pump hydraulic fluid channels that have first ends fluidly connected to the second hydraulic pump main body and second ends opened to the outer surface.

4. A working vehicle with front-mount mower according to claim 1, wherein the first and second hydraulic motor main bodies are fluidly connected in parallel to the hydraulic pump main body.

5. A working vehicle with front-mount mower according to claim 1, further comprising a first wheel motor device for driving the left driving wheel and a second wheel motor device for driving the right driving wheel, wherein
the first wheel motor device includes the first hydraulic motor main body, a first deceleration mechanism that decelerates rotational power output from the first hydraulic motor main body, a first output member that outputs the rotational power decelerated by the first deceleration mechanism to the left driving wheel, and a first housing that accommodates the first hydraulic motor main body and the first deceleration mechanism and that supports the first output member, the first housing being formed with a pair of first-motor hydraulic fluid channels having first ends fluidly connected to the first hydraulic motor main body and second ends opened to an outer surface, and being directly or indirectly supported by the left main frame; and
the second wheel motor device includes the second hydraulic motor main body, a second deceleration mechanism that decelerates rotational power output from the second hydraulic motor main body, a second output member that outputs the rotational power decelerated by the second deceleration mechanism to the right driving wheel, and a second housing that accommodates the second hydraulic motor main body and the second deceleration mechanism and that supports the second output member, the second housing being formed with a pair of second-motor hydraulic fluid channels having first ends fluidly connected to the second hydraulic motor main body and second ends opened to an outer surface, and being directly or indirectly supported by the right main frame.

6. A working vehicle with front-mount mower according to claim 1, wherein
the driving power source has an output shaft extending substantially horizontally; and
the PTO-side transmission mechanism includes a driving pulley supported by the output shaft in a relatively non-rotatable manner, and an endless belt that is wound around the PTO-side driving pulley so as to rotate along a rotational trajectory in a substantially vertical surface and that functions as the PTO-side power transmission member.

7. A working vehicle with front-mount mower according to claim 1, wherein the PTO-side power transmission member is a PTO-side transmission shaft provided at both ends with universal joints.

8. A working vehicle with front-mount mower according to claim 1, wherein the driving power source is disposed higher than the driving wheels and between a driver's seat and the container in the vehicle lengthwise direction.

9. A working vehicle with front-mount mower according to claim 1, wherein the driving power source is disposed rearward of the pair of driving wheels and below the container.
